(19) United States
(12) Patent Application Publication
(10) Pub. No.: US 2004/0258082 A1
(43) Pub. Date: Dec. 23, 2004

(54) Communication system

(75) Inventor: Hiroshi Morisaki, Aichi-ken (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/809,428

(22) Filed: Mar. 26, 2004

(30) Foreign Application Priority Data
Mar. 28, 2003 (JP) P2003-092432
Mar. 28, 2003 (JP) P2003-092433

(51) Int. Cl. H04L 12/54; H04L 12/28

(52) U.S. Cl. 370/412; 370/428

(57) ABSTRACT

A communication system including a communication device (multifunction device) and a terminal device (personal computer) enables communication details in the communication device to be saved and managed more easily on the terminal device end. When image data is stored in a RAM of the multifunction device in a shared area thereof, this data is automatically recorded to the personal computer end. Hence, after the multifunction device stores image data transmitted or received through facsimile communications, the user need not perform an operation on the personal computer to record this data on the personal computer end. Further, if the available capacity in the shared area is insufficient to store the received image data, the multifunction device stores the image data in the shared area one page at a time. Since each single page worth of image data stored in the shared area is subsequently deleted after being recorded on the personal computer end, image data received by the multifunction device can still be recorded on the personal computer end using a storage area that is smaller than the image data.

### BACKGROUND OF THE INVENTION

The present invention relates to a communication system for transmitting and receiving data, a communication device and a terminal device serving as components of the communication system, and a computer program that can be used on these devices.

Communication devices that function as facsimile machines, for example, are well known in the art. Generally, such communication devices are configured to accumulate details of data communications (such as the transmission destination, transmission source, communication date and time, duration of communication, and number of pages) in a memory and to print the accumulated communication details on paper when a prescribed operation is performed. In this way, the user can confirm the details of communications on paper.

In recent years, various technologies have been proposed for enabling a user to view communication details accumulated by a communication device from a terminal device that is connected to and capable of performing data communications with the communication device.

In such a communication device (data input output device) is provided a storage unit (RAM 12) that a terminal device (personal computer PC 200) can recognize as an external storage device connected to the terminal device itself as described in Japanese patent application publication No. 2001-282694. When the communication device stores data representing details of communications (facsimile transmission/reception data) in this storage unit, the user can freely access these communication details from the terminal device. This communication device facilitates the transfer of data representing communication details accumulated by the communication device to the terminal device side and is suitable for saving and managing such communication details on the terminal device.

However, since data representing communication details is simply recorded on the communication device described above in a form that can be accessed by the terminal device, the user of the terminal device must intentionally perform a troublesome task to save the data stored in the storage unit of the communication device on the terminal device end.

From this perspective, the communication device described above is not particularly user-friendly for saving and managing communication details on the terminal device end. For example, when data is stored in the communication device, the user must perform operations to search for data representing communication details and, after confirming that the data stored in the storage unit of the communication device is such data, must subsequently perform an operation to save this data on the terminal device end. These operations may result in data unrelated to communication details being mistakenly stored on the terminal device end.

### SUMMARY OF THE INVENTION

In view of the foregoing, it is an object of the present invention to provide a communication system for facilitating the saving and management of communication details on the terminal device end, the communication details being accumulated in the communication device.

This and other objects of the present invention will be attained by an improved communication system including a communication device and a terminal device that are connected to and capable of performing data communications with each other. The communication device includes a communicating unit, a communication-end storing unit, and a communication-storage commanding unit. The communicating unit performs data communications via a network. The communication-end storing unit is capable of storing various data and capable of being recognized by the terminal device as an external storage device connected to the terminal device. The communication-storage commanding unit includes a judging portion that judges whether or not a communication data transmitted through or received by the communicating unit is satisfied with a prescribed storage condition, a storing portion that stores a communication data in the communication end storing unit if the communication data is satisfied with the prescribed condition as a result of judgment by the judging portion, a handling portion that handles a communication data as a plurality of data segments each having a prescribed data size if the communication data is not satisfied with the prescribed condition as a result of judgment by the judging portion, and a sequentially storing portion that sequentially stores the data segments in the communication-end storing unit. The terminal device includes a terminal-end storing unit that stores various data, and a terminal-end storage commanding unit that stores the communication data or the data segments in the terminal-end storing unit when the communication data or data segments are stored in the communication-end storing unit.

Preferably, the terminal device further includes a terminal-end deletion commanding unit that deletes the communication data or the data segments from the communication-end storing unit after the communication data or data segments have been stored in the terminal-end storing unit by the terminal-end storage commanding unit.

In another aspect of the invention, there is provided an improved communication system including a communication device and a terminal device that are connected to and capable of performing data communications with each other. The communication device includes a communicating unit, a communication-end storing unit, and a communication-end storage commanding unit. The communicating unit performs unit. The communicating unit performs data communications via a network. The communication-end storing unit is capable of storing various types of data and is capable of being recognized by the terminal device as an external storage device connected to the terminal device. The communication-end storage commanding unit stores description data indicating details of communications performed by the communicating unit in the communication-end storing unit in a state that satisfies a prescribed storage condition. The terminal device includes terminal-end storing unit for storing various types of data and terminal-end storage commanding unit for treating the description data as the data for satisfying the storage condition and storing in the terminal-end storing unit the description data from among all data stored in the communication-end storing unit.

Preferably, the terminal device further includes a terminal-end deletion commanding unit that deletes data from the communication-end storing unit that is identical to data stored in the terminal-end storing unit by a command from the terminal-end storage commanding unit.

In still another aspect of the invention, there is provided a first storage medium containing a program for performing data communication between a communication device and a terminal device. The communication device includes a communication-end storing unit capable of storing various data and capable of being recognized by the terminal device as an external storage device connected to the terminal device. The first program includes a program of performing data communication via a network, and a program of commanding storage in the communication-end storing unit including a program of judging whether or not a communication data transmitted through or received by the communicating unit is satisfied with a prescribed storage condition, a program of storing a communication data in the communication end storing unit if the communication data is satisfied with the prescribed condition as a result of the judgment, a program of handling a communication data as a plurality of data segments each having a prescribed data size if the communication data is not satisfied with the prescribed condition as a result of the judgment, and a program of sequentially storing the data segments in the communication-end storing unit.

A second storage medium containing a program for performing data communication between a communication device and a terminal device is further provided for use in combination with the first storage medium. The terminal device includes a terminal-end storing unit that stores various data. The program includes a program of commanding storage of the communication data or the data segments in the terminal-end storing unit when the communication data or data segments are stored in the communication-end storing unit.

Preferably, the second storage medium further comprises a program of commanding deletion of the communication data or the data segments from the communication-end storing unit after the communication data or data segments have been stored in the terminal-end storing unit.

In still another aspect of the invention, there is provided a third storage medium containing a program for performing data communication between a communication device and a terminal device. The communication device includes communication-end storing unit capable of storing various types of data and capable of being recognized by the terminal device as an external storage device connected to the terminal device. The program includes a program of performing data communications via a network, and a program of commanding storage in the communication-end storing unit of description data indicating details of communications performed by the data communication program in the communication-end storing unit in a state that satisfies a prescribed storage condition.

A fourth storage medium containing a program for performing data communication between a communication device and a terminal device is further provided for use in combination with the third storage medium. The terminal device includes a terminal-end storing unit that stores various types of data. The program includes a program of treating the description data as the data for satisfying the storage condition and commanding storage in the terminal-end storing unit of the description data from among all data stored in the communication-end storing unit.

Preferably, the fourth storage medium further includes a program of deleting data from the communication-end storing unit that is identical to data stored in the terminal-end storing unit by a command from the commanding program.

### BRIEF DESCRIPTION OF THE DRAWINGS

In the drawings:

FIG. 1 is a block diagram showing a structure of a communication system according to first through sixth embodiments of the present invention;

FIG. 2 is a top view showing an appearance of a multifunction device used in the communication system according to the first embodiment;

FIG. 3 is a flowchart showing steps in a fax reception process according to the first embodiment;

FIG. 4 is an explanatory diagram showing a structure of specification data according to the first embodiment;

FIG. 5 is a flowchart showing steps in a data acquisition process according to the first embodiment;

FIG. 6 is a flowchart showing steps in a data acquisition process according to a modification to the process in FIG. 5;

FIG. 7 is a flowchart showing steps in a fax reception process according to the second embodiment;

FIG. 8 is a flowchart showing steps in a mode switching process according to the third embodiment;

FIG. 9 is a flowchart showing steps in a fax reception process according to the third embodiment;

FIG. 10 is a flowchart showing steps in a fax reception process according to the fourth embodiment;

FIG. 11 is a flowchart showing steps in a facsimile communication process according to the fifth embodiment;

FIG. 12(a) shows a FAXHISTORY folder created under a root directory of a shared area according to the fifth embodiment;

FIG. 12(b) shows folders a structure of directories acknowledged in a personal computer as a terminal device according to the fifth embodiment;

FIG. 13 is a flowchart showing steps in history accumulation process according to the fifth embodiment;

FIG. 14 is a flowchart showing steps in a facsimile communication process according to the sixth embodiment; and

FIG. 15 is a flowchart showing steps in history accumulation process according to the sixth embodiment.

### DESCRIPTION OF THE PREFERRED EMBODIMENTS

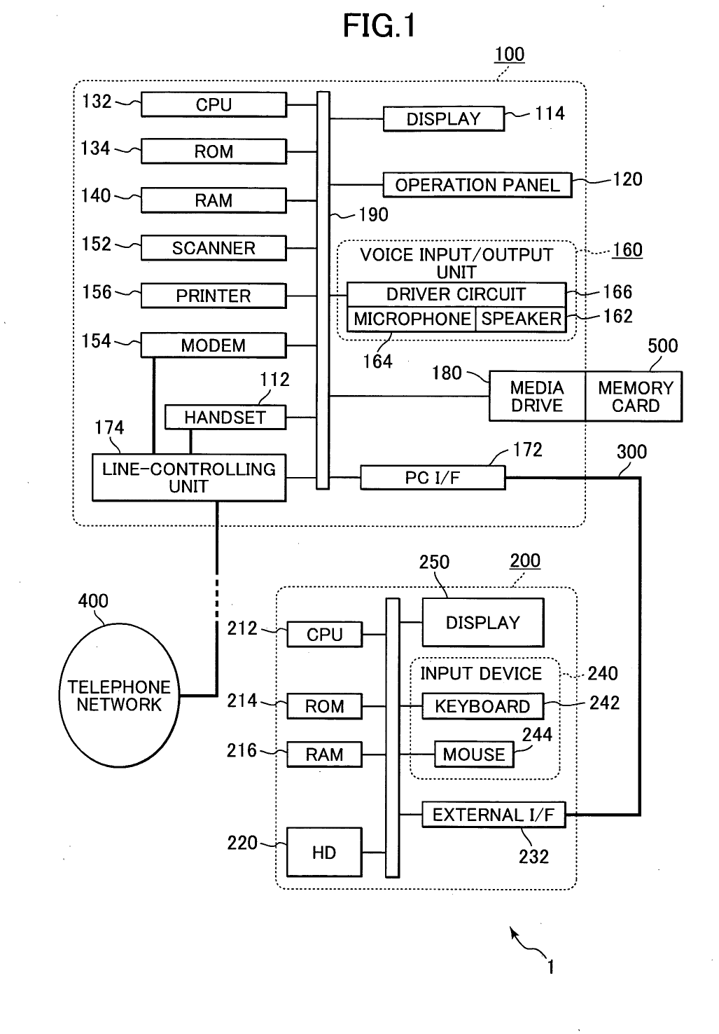

Next, a communication system according to a first embodiment of the present invention will be described with reference to FIGS. 1 through 5.

As shown in FIG. 1, the communication system 1 includes a multifunction device 100 and a personal computer (hereinafter referred to as PC 200) 200 that are connected to the multifunction device 100 and capable of performing data communications via a communication cable 300.

The multifunction device 100 functions as a telephone terminal, a facsimile machine, a copier, a scanner, and the like. The multifunction device 100 includes a handset 112, a display panel 114, an operation panel 120, a CPU 132, a ROM 134, a RAM 140, a scanning unit 152, a modem 154, a printing unit 156, a voice input/output unit 160, a PC interfacing unit (hereinafter referred to as PC I/F) 172, a circuit-controlling unit 174, a media drive 180, and the like.

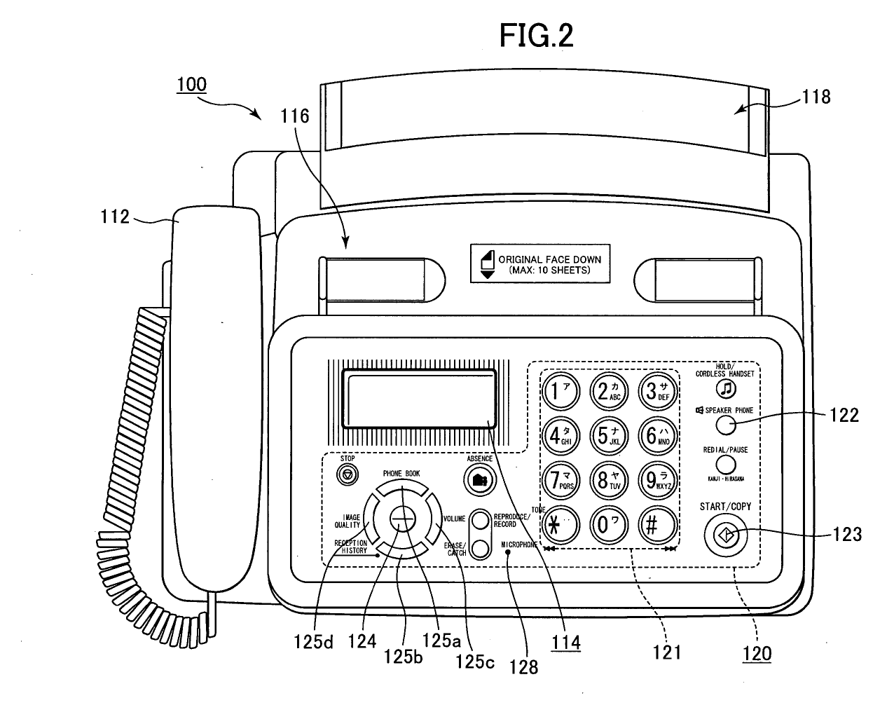

Here, the handset 112 is a transceiver mounted on the side of a body of the multifunction device 100, as shown in FIG. 2, and is used when removed from the body of the multifunction device 100. Further, the display panel 114 is provided on the top of the body of the multifunction device 100 for receiving commands from the CPU 132 and displaying various data.

The operation panel 120 is also provided on the top of the body of the multifunction device 100 and includes a plurality of input buttons 121 for inputting characters, numerals and symbols, a speakerphone button 122 for implementing a hands-free call with the voice input/output unit 160, a start button 123 for initiating execution of the various functions, a function-selecting button 124, directional buttons 125, and the like. The directional buttons 125 include an up button 125a, a down button 125b, a left button 125c, and a right button 125d.

The CPU 132 controls overall operations of the multifunction device 100 by transmitting commands (control signals) via a bus 190 to the various components of the multifunction device 100 according to a procedure directed by a computer program that is stored in the ROM 134.

A part of the storage area in the RAM 140 is a shared area that the PC 200 connected to the multifunction device 100 can recognize as an external storage device (virtual drive) connected to the PC 200 itself. Accordingly, the PC 200 can recognize the shared area as a storage area that can be accessed (to store and delete data) by a file system, which is part of a function provided standard in an OS (operating system). This shared area has a tree-like folder structure (also called a directory) for sorting and storing data files in folders.

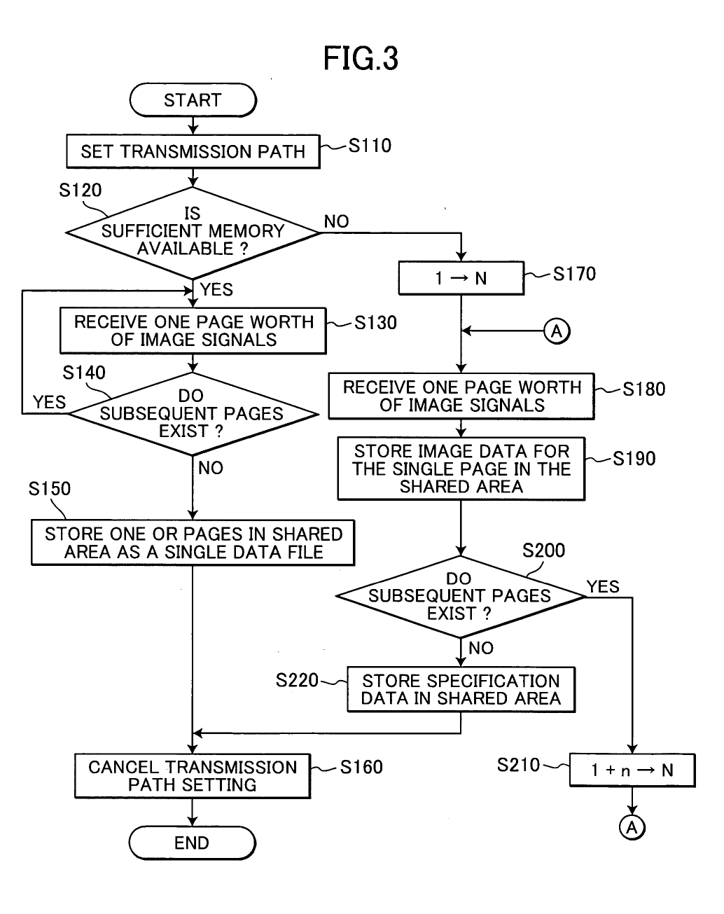

The scanning unit 152 is adapted to receive commands from the CPU 132 and to scan images from paper loaded in a prescribed scanning position 116 (see FIG. 2) to generate image data based on these images. Such process is executed in a fax reception process described later (see FIG. 3). The modem 154 is adapted for encoding and modulating the image data generated by the scanning unit 152 to generate image signals that can be transferred to a telephone network 400. Subsequently, the image signals are output to the telephone network 400 via the circuit-controlling unit 174.

In the fax reception process described later (FIG. 3), the printing unit 156 receives commands from the CPU 132 and prints images based on image data on paper loaded in a prescribed paper feeding position 118 (FIG. 2). Image data on which printing of the image is based is generated, for example, from image signals inputted from the telephone network 400 via the circuit-controlling unit 174, the image signals being demodulated and decoded by the modem 154.

The voice input/output unit 160 includes a speaker 162, a microphone 164, and a drive circuit 166 for driving the speaker 162 and microphone 164. In addition to outputting voice from the speaker 162 based on various voice signals, the voice input/output unit 160 can be used for performing a hands-free call by controlling the speaker 162 and microphone 164 to function as a transceiver. The microphone 164 of the voice input/output unit 160 is mounted on the underside of the operation panel 120 and positioned below a hole 128 formed therein (see FIG. 2). Voice is inputted into the microphone 164 via the hole 128.

The PC I/F 172 is an interface for connecting the multifunction device 100 to the PC 200 via the communication cable 300, by which data communications is made possible between the multifunction device 100 and PC 200.

The circuit-controlling unit 174 inputs various signals from the telephone network 400 and outputs signals to the telephone network 400. The circuit-controlling unit 174 also receives commands from the CPU 132 and sets the transmission path including a transmission destination and a transmission source for signals inputted from and outputted to the telephone network 400.

When performing an off-hook operation by removing the handset 112 from the body of the multifunction device 100 or by pressing a speakerphone button 122 on the operation panel 120 (this is an operation to initiate a hands-free call), the transmission path for the destination and source of signals inputted from and outputted to the telephone network 400 is set to a path from the circuit-controlling unit 174 to the handset 112 or the voice input/output unit 160, enabling voice signals to be transmitted along this path. The transmission path established in this way is disconnected upon execution of an on-hook operation in which the handset 112 is returned to the body of the multifunction device 100 or the speakerphone button 122 is pressed a second time (this is an operation to end the hands-free call), thereby preventing voice signals from being transmitted on the path.

If a series of operations is performed while paper to be scanned is set in the scanning position 116 in which operations an identification number for a transmission destination (a telephone number in the present embodiment) is inputted by input buttons 121 on the operation panel 120 and subsequently the start button 123 is pressed (hereinafter referred to as a fax transmission operation), or when the input of image signals is initiated on the telephone network 400 end, the path to the modem 154 is set as the transmission path, enabling the transmission of image signals along this path. When the output of image signals by the modem 154 ends or when input of image signals from the telephone network 400 ends, this transmission path is disconnected preventing further transmission of image signals on the path (see the fax reception process described later with reference to FIG. 3).

The media drive 180 accepts mounting of a memory card 500 and can read data from a mounted memory card 500 or record data thereon. “Memory card” in the present embodiment refers to such media as CompactFlash (registered trademark), SmartMedia (registered trademark), Memory Stick (registered trademark), MultiMediaCard, and SD Memory Card.

The PC 200 includes a CPU 212, a ROM 214, a RAM 216, a hard disk (hereinafter abbreviated as HD) 220, an external interfacing unit (hereinafter referred to as an external I/F) 232, an input unit 240, a display 250, and the like connected to one another via a bus 260.

In addition to various application programs, the HD 220 stores a data acquisition program for executing a data acquisition process described later (FIG. 5), and the like. The external I/F 232 is an interface for connecting the PC 200 to the multifunction device 100 via the communication cable 300, by which data communications is enabled between the PC 200 and the multifunction device 100. The input unit 240 serves as an input device including a keyboard 242 and a mouse 244.

Fax reception process executed by the CPU 132 of the multifunction device 100 will be described with reference to FIG. 3. This process begins when image signals are first inputted from the telephone network 400 via the circuit-controlling unit 174.

First, in S110, the CPU 132 enables the circuit-controlling unit 174 to establish a path connecting the modem 154 to the telephone network 400 as the signal transmission path. This process enables image signals to be transferred along the path connecting the modem 154 and the telephone network 400.

In S120, the CPU 132 determines whether the available capacity in the shared area of the RAM 140 is sufficient for storing the image data received through facsimile communications. In this process, the CPU 132 determines that the available capacity of the shared area is sufficient for storing the image data when greater than or equal to a prescribed threshold value (256 kbytes in the preferred embodiment).

If the available capacity in the shared area is sufficient for storing the image data (S120: YES), then in S130, the CPU 132 performs facsimile communications to receive image signals for one page worth of image data.

In S140, the CPU 132 determines whether subsequent pages of data exist. In this process, subsequent pages are determined to exist if the reception of image signals for a following page begins after completing reception of image signals for the single page worth of data in S130. If the CPU 132 determines that subsequent pages exist (S140: YES), then the CPU 132 returns to S130.

When the CPU 132 determines that no subsequent pages exist in S140 after repeatedly performing the processes of S130 and S140 (S140: NO), then in S150 the CPU 132 stores image data for an image represented by the one or more pages worth of image signals received in S130 in the shared area of the RAM 140 as a single data file. In this process, the modem 154 generates one or more pages worth of image data by demodulating and decoding the one or more pages worth of image signals received in the repeated processes of S130. The resulting image data is then stored in the shared area of the RAM 140. Once stored in the shared area, this image data is read and deleted from the shared area in a data acquisition process described later (FIG. 5) executed on the PC 200 end. In the process of S150, the image data is recorded under a filename that includes a sequence of numbers formed from the date and time at which the process in S130 was executed. For example, if the communication occurred on the date “Mar. 20, 2003” and at the time “9:45,” the filename is set to “rx200303200945.”

In S160, the CPU 132 cancels the transmission path setting in the circuit-controlling unit 174 connecting the modem 154 and the telephone network 400 and subsequently ends the fax reception process. The process in S160 prevents image signals from being transferred along the path between the modem 154 and the telephone network 400.

However, if the available capacity in the shared area is found to be insufficient for storing the image data (S120: NO), then in S170 the CPU 132 initializes a variable N to 1 (N←1). An “n” used in the description below indicates the value to which the variable N is set.

In S180 the CPU 132 performs facsimile communications to receive one page worth of image signals. In S190 the CPU 132 stores image data for an image represented by the one page worth of image signals received in S180 in the shared area of the RAM 140. In this process, the modem generates one page worth of image data by demodulating and decoding the one page worth of image signals received in S180, and the resulting image data is stored in the shared area of the RAM 140. Once stored in the shared area, the image data is read and deleted in a data acquisition process described later (FIG. 5) executed on the PC 200 end. In the process of S190, the image data is recorded under a filename that includes a series of numbers formed of the date and time at which the process in S180 was executed and the value of the variable N (that is, the page number). For example, if the communication was performed on the date “Mar. 20, 2003” and at the time “9:45,” and if the value of the variable N is “1,” then the filename is set to “rx200303200945p001.”

In S200, the CPU 132 determines whether subsequent pages exist. In this process, the CPU 132 determines that subsequent pages exist when the reception of image signals for a following page begins after completing reception of image signals for the single page worth in S180.

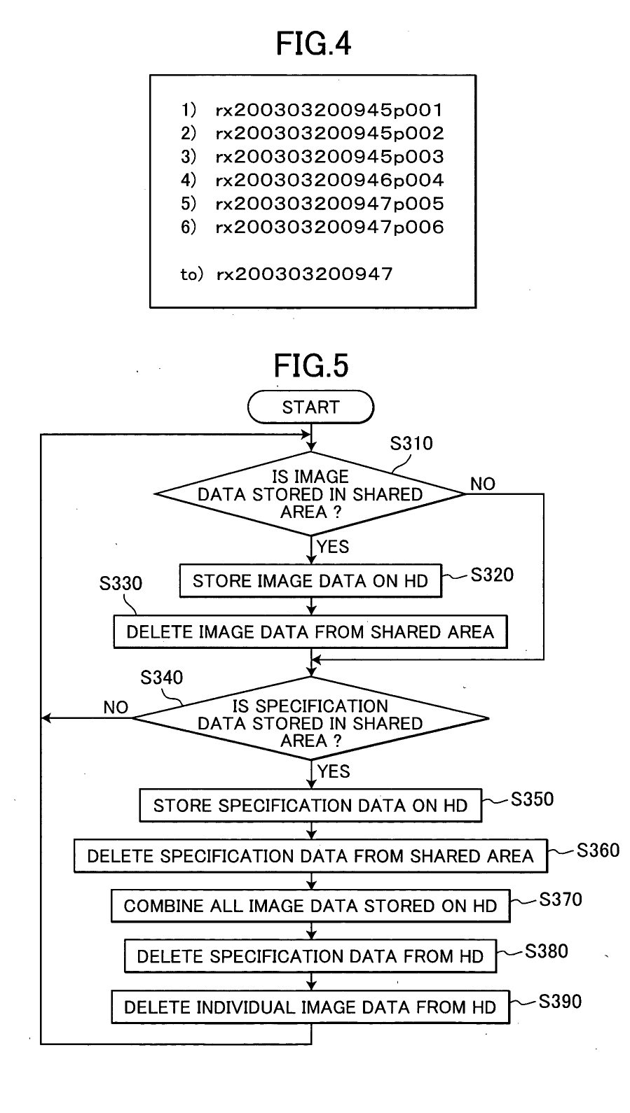

If the CPU 132 determines that subsequent pages exist (S200: YES), then in S210 the CPU 132 increments the variable N by 1 (N←n+1) and returns to S180. When subsequent pages no longer exist after repeatedly performing the processes from S180 to S210 (S200: NO), then in S220, the CPU 132 generates specification data specifying that the one or more pages worth of image data stored in the shared area in S190 was received in a single facsimile communication, and stores this specification data in the shared area of the RAM 140. The specification data generated and stored in the shared area of the RAM 140 in the process or S190 is text data, such as that shown in FIG. 4. This text data specifies a filename for each page worth of the image data stored in S190 and a filename for the image data to be generated by combining all pages of image data (hereinafter referred to as the combined filename). Once stored in the shared area this specification data is read and deleted in the data acquisition process described later (FIG. 5) executed on the PC 200 end. In the preferred embodiment, the combined filename is created by deleting the page number from the filename of image data stored in S190 having the largest page number (“t0) rx200303200947” in FIG. 4). After completing the process in S220, the CPU 132 cancels the transmission path setting in S160 and ends the fax reception process.

It should be noted that processes related to normal facsimile communications involve sequentially printing each page worth of image data with the printing unit 156 after the modem generates each page worth of image data by demodulating and decoding each page worth of image signals sequentially inputted from the telephone network 400 via the circuit-controlling unit 174. A description of this printing process, which is performed while executing the processes from S130 to S140 and from S180 to S210 described above, has been omitted since such a printing process is not important for understanding the present invention.

Next, a data acquisition process executed by the CPU 212 of the PC 200 will be described with reference to FIG. 5. This process is repeatedly executed while the data acquisition program is running.

First, in S310 the CPU 212 determines whether image data has been stored in the shared area of the RAM 140. Image data is stored in the shared area during the processes of S150 and S190 in FIG. 3 executed on the multifunction device end.

If image data has been stored in the shared area (S310: YES), then in S320 the CPU 212 reads this image data and stores the image data on the HD 220. In this process, the image data is stored in a predetermined storage area of the HD 220 allocated for storing image data. In S330 the CPU 212 deletes the original image data from the shared area, the original image data being identical with the image data stored in the HD 220.

After completing the process of S330, or if image data has not been stored in the shared area in S310 (S310: NO), then in S340 the CPU 212 determines whether specification data has been stored in the shared area of the RAM 140. Specification data is stored in the shared area during the process of S220 of FIG. 3 executed on the multifunction device end.

If specification data has not been stored in the shared area (S340: NO), then the CPU 212 returns to S310. By repeatedly performing the processes from S310 to S340, image data that the multifunction device repeatedly stores in the shared area during the processes from S180 to S220 in FIG. 3 is sequentially read and stored in the HD 220 and is subsequently deleted from the shared area.

However, if specification data has been stored in the shared area (S340: YES), then in S350 the CPU 212 reads this specification data and stores the data on the HD 220. In this process, the specification data is stored in a predetermined storage area of the HD 220 allocated for storing specification data.

In S360 the CPU 212 deletes the original specification data from the shared area, the original specification data being identical with the specification data stored in the HD 220.

In S370 the CPU 212 generates a single data file by combining each image data stored in S320 based on specification data stored on the HD 220 in S350. In this process, the image files specified by the specification data are concatenated in a sequence based on their page numbers to form a single image data file having a combined filename also specified by the specification data.

In S380 the CPU 212 deletes the specification data stored in S350 from the HD 220. In S390 the CPU 212 deletes each file of image data stored in the processes of S320 from the HD 220 and returns to S310.

With the communication system 1 having this construction, image data or specification data stored on the multifunction device end in the shared area of the RAM 140 (S150, S190, and S220 of FIG. 3) can subsequently be stored in the HD 220 on the PC 200 end automatically (S320 and S350 of FIG. 5). Therefore, when the multifunction device 100 performs facsimile communications, and image data received through these communications or generated specification data is stored on the multifunction device 100 end, the user of the PC 200 need not perform an intentional operation to store this data on the PC 200 end. Accordingly, the communication system 1 of the present embodiment makes it easier to save and manage image data received by the multifunction device 100 or generated specification data on the PC 200 end than conventional devices that require the user to perform an intentional operation.

Further, since data stored on the multifunction device end in the shared area of the RAM 140 is later deleted from the shared area after being stored on the PC 200 end (S330 and S360 of FIG. 5), unnecessary data is not allowed to occupy the storage area on the multifunction device 100 end, thereby enabling effective use of this storage area.

Further, if the available capacity of the shared area is insufficient when receiving image data on the multifunction device 100 end, the CPU 212 sequentially stores one page worth of image data at a time in the shared area (S180-S210 of FIG. 3). Each time one page worth of image data is stored in the shared area, the image data is sequentially stored on the PC 200 end and subsequently deleted from the shared area. Accordingly, image data received by the multifunction device 100 can be transferred to the PC 200 end using a storage area that is smaller than the image data itself.

Further, by storing specification data in association with each page worth of image data in the shared area (S220 of FIG. 3), these pages of image data can be combined into a single data file on the PC 200 end based on this specification data (S370 of FIG. 5).

Further, if the available capacity of the shared area in the RAM 140 is smaller than a prescribed threshold value (S120 of FIG. 3), the image data can be sequentially stored in the shared area one page worth at a time (S190). The “threshold value” in the preferred embodiment is the available capacity thought to be sufficient for storing image data received through facsimile communications. When the available capacity of the shared area is smaller than the capacity thought to be sufficient for storing the image data, the image data can be stored sequentially one page at a time, thereby making efficient use of a small available capacity to store image data on the PC 200 end.

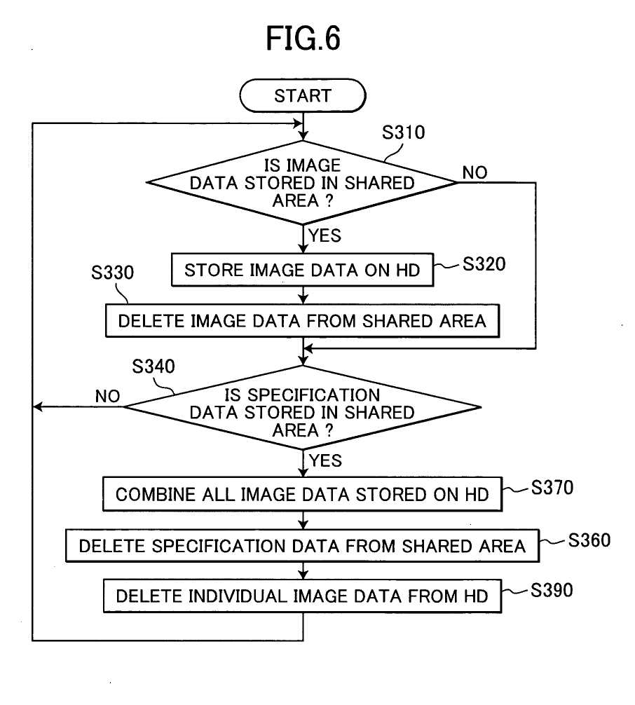

FIG. 6 shows data acquisition process according to a modification to the data acquisition process of FIG. 5. In the data acquisition process of FIG. 5, specification data is stored on the HD 220 in S350 and, after deleting this specification data from the multifunction device 100 end in S360, image data is generated in S370 based on the specification data stored on the HD 220. In contrast, according to the modification shown in FIG. 6, the steps S350 and S380 of FIG. 5 are dispensed with. Instead, in the process of S370 of FIG. 6, the image data is generated based on the specification data stored on the multifunction device 100 end. In this case, as shown in FIG. 6, image data is generated in S370 based on specification data that was stored on the multifunction device 100 end in S340, and the specification data is subsequently deleted from the multifunction device 100 end in S360. Because the specification data has not been recorded in the HD 220, the step of deleting the specification data from the HD 220 such as S380 is not required.

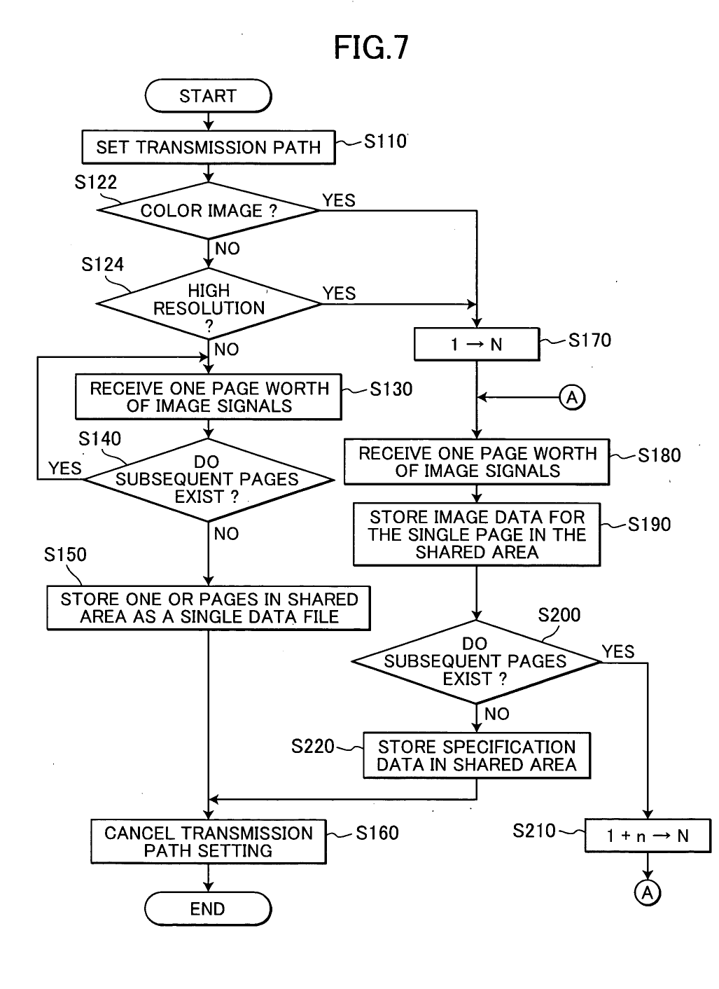

A communication system according to a second embodiment of the present invention will be described with reference to FIG. 7. The second embodiment is identical in configuration to the communication system 1 of the first embodiment with differences only in a portion of the process executed by the communication systems. Therefore, only these differing points will be described below.

A fax reception process executed by the CPU 132 of the multifunction device 100 according to the second embodiment is nearly identical to the process of the first embodiment shown in FIG. 3, except that the process of S120 in FIG. 3 is replaced by the processes of S122 and S124 described below. These processes are described next with reference to FIG. 7.

After the transmission path has been established in S110, in S122 the CPU 132 determines whether image data received through facsimile communications is color image data. In normal facsimile communications, informational signals are exchanged prior to transferring the actual image signals. These informational signals indicate whether the image data represented by the image signals is color or monochrome data and whether this image data is normal resolution or high resolution (a resolution higher than normal resolution). Hence, in S122 the CPU 132 determines whether the image data is color data based on these informational signals. If the image data to be received through facsimile communications is determined to be color image data (S122: YES), then the CPU 132 advances to S170.

However, if the image data to be received through facsimile communications is determined to be monochromatic image data (S122: NO), then the CPU 132 determines in S124 whether the image data is high-resolution data. In this process, the CPU 132 determines whether the image data is normal-resolution or high-resolution data based on the informational signals described above. If the CPU 132 determines that the image data received through facsimile communications is high-resolution image data (S124: YES), then the CPU 132 advances to S170. However, if the image data is normal resolution (S124: NO), then the CPU 132 advances to S130.

The communication system having the construction described above can achieve the following effects owing to the operational differences from the communication system 1 of the first embodiment.

With the communication system of the second embodiment, when image data received by the multifunction device 100 through facsimile communications is either color image data or high-resolution data (S122 and S124 of FIG. 7), the image data can be sequentially stored in the shared area one page at a time (S180-S210). Since color or high-resolution image data normally has a larger volume than monochromatic or normal resolution image data, this large volume of image data is likely to take up most of the available space in the shared area or to exceed the available capacity of the shared area if the image data is stored all at once. Therefore, color or high-resolution image data is sequentially stored after each page worth of image data is received, thereby preventing the image data from occupying the majority of the storage area in the shared area and avoiding failures in storing the image data properly when the image data is larger than the available capacity in the shared area. As a result, image data stored in the multifunction device 100 can be recorded on the PC 200 end while effectively using the available capacity of the shared area. In this way in the second embodiment, the numbers of colors and the resolution function as parameters for determining storage mode.

A communication system according to a third embodiment of the present invention will next be described with reference to FIGS. 2, 8 and 9. The third embodiment has a construction identical to the communication system 1 of the first embodiment with differences existing only in part of the process performed. Therefore, only these differing points will be described below.

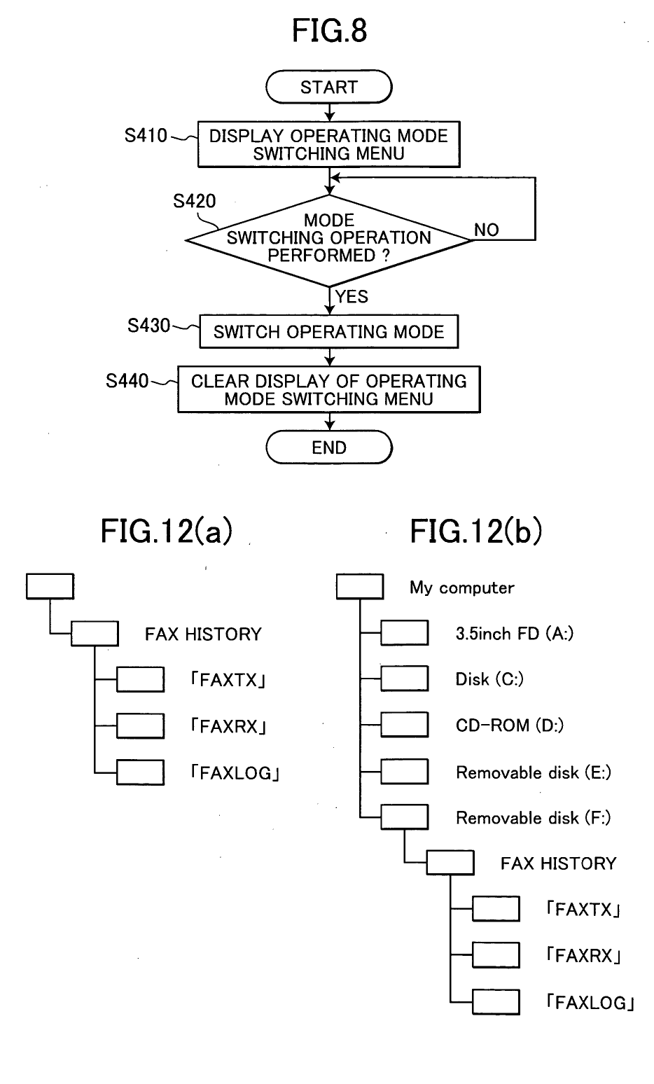

A mode switching process executed by the CPU 132 of the multifunction device 100 will first be described with reference to FIG. 8. This process begins when the function-selecting button 124 in the operation panel 120 is pressed twice consecutively.

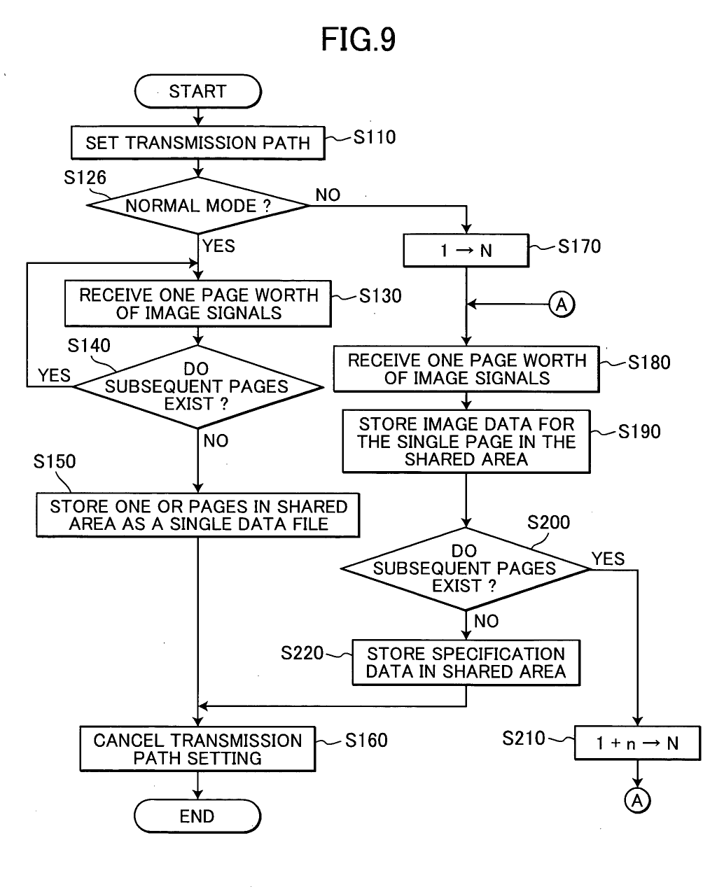

In S410 the CPU 132 displays an operating mode switching menu on the display panel 114. The operating mode switching menu displayed in this process prompts the user to switch the operating mode of the multifunction device 100 to either a “normal mode” for storing image data unchanged in the shared area of the RAM 140 during the fax reception process described later (FIG. 9) or a “divided mode” for sequentially storing the image data in the shared area of the RAM 140 one page at a time. Once the operating mode switching menu is displayed on the display panel 114, the user operates the directional buttons 125 in the operation panel 120 to select either the normal mode or the divided mode and subsequently confirms the selection by pressing the function-selecting button 124.

In the meantime, the CPU 132 waits until the mode confirming operation has been performed (S420: NO). When the mode confirming operation has been performed (S420: YES), the CPU 132 switches the operating mode in S430. In this process, a variable M is set to a value used to indicate the operating mode. To switch the operating mode, the variable M, which has been initialized to zero, is set to a value corresponding to the operating mode determined by the mode confirming operation. More specifically, the variable M is set to “0” (M←0) when the operating mode has been set to the “normal mode” and “1” (M←1) when the operating mode has been set to the “divided mode.” In the following description, “m” indicates the value to which the variable M is currently set. In S440 the CPU 132 clears the operating mode switching menu from the display panel 114 and ends the mode switching process.

Next, a fax reception process executed by the CPU 132 of the multifunction device 100 will be described. The fax reception process according to the third embodiment of the present invention is nearly identical to that shown in FIG. 3, except that the process of S120 in FIG. 3 is replaced by the process of S126 described below. This process will be described with reference to FIG. 9.

After establishing a transmission path in S110, in S126 the CPU 132 checks the operating mode of the multifunction device 100. In this process, the CPU 132 determines whether the operating mode switched in the mode switching process of FIG. 8 is the “normal mode” or the “divided mode” based on the value of the variable M (M=0: normal mode, M=1: divided mode).

If the operating mode is the “normal mode” (S126: YES), then the CPU 132 advances to S130. However, if the operating mode is the “divided mode” (S126: NO), then the CPU 132 advances to S170.

The communication system having the construction described above achieves the following effects owing to the differences in operations from those performed in the first embodiment.

With the communication system having this construction, the multifunction device 100 can store image data sequentially one page at a time (S180-S210 in FIG. 9) when the operating mode of the multifunction device 100 has been switched to the divided mode (S126). Since the operating mode of the multifunction device 100 can be switched in the mode switching process of FIG. 8 upon operation by the user, the user can determine whether to store the image data in its entirety or for each page worth of data.

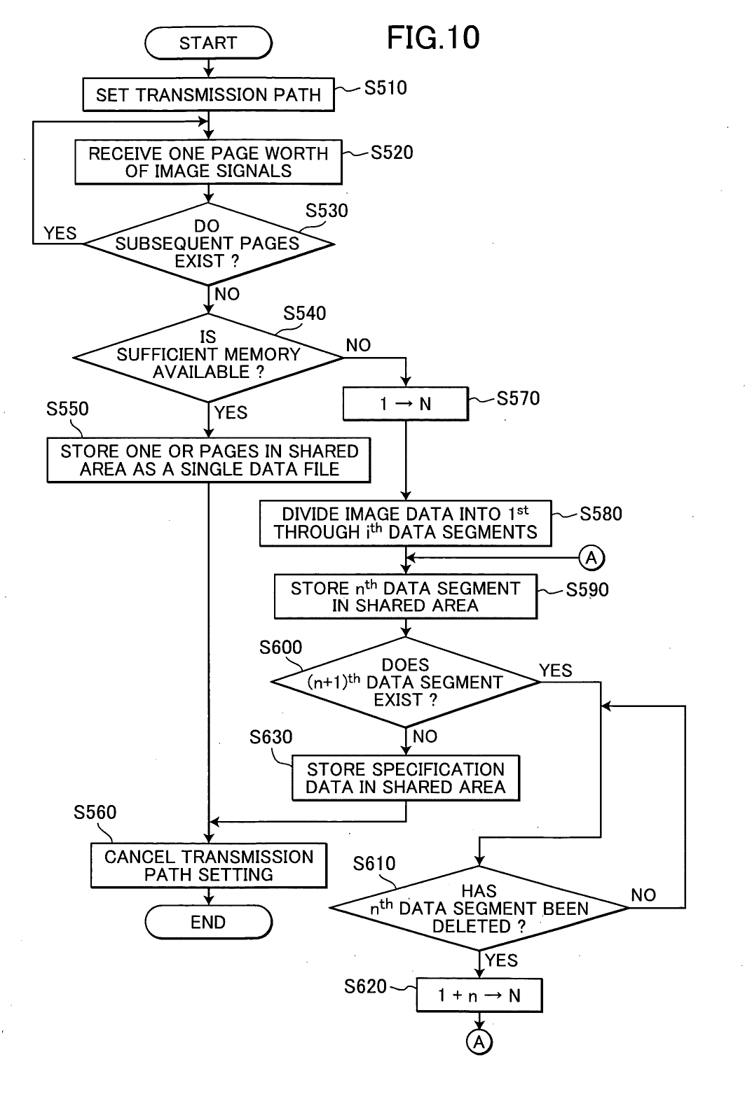

A communication system according to a fourth embodiment of the present invention will next be described with reference to FIG. 10. The forth embodiment has a construction identical to the communication system 1 of the first embodiment.

A fax reception process executed by the CPU 132 of the multifunction device 100 will first be described. This process begins when image signals are initially inputted from the telephone network 400 via the circuit-controlling unit 174.

In S510 the CPU 132 sets the signal transmission path in the circuit-controlling unit 174 as a path connecting the modem 154 and the telephone network 400. In S520 the CPU 132 performs facsimile communications to receive a single page worth of image signals.

In S530 the CPU 132 determines whether subsequent pages of image data exist. This process is identical to the process of S140 in FIG. 3. If the CPU 132 determines that subsequent pages of image data exist (S530: YES), then the CPU 132 returns to S520.

When no subsequent pages exist in S530 after repeatedly performing the processes in S520 and S530 (S530: NO), then in S540 the CPU 132 determines whether the available capacity in the shared area of the RAM 140 is sufficient for storing the image data received through facsimile communications. This process is identical to the process of S120 in FIG. 3.

If the CPU 132 determines that the available capacity in the shared area is sufficient for storing the image data (S540: YES), then in S550 the CPU 132 stores image data for an image represented by one or more pages worth of image signals, which have been received by repeatedly performing the process of S520, in the shared area of the RAM 140 as a single data file. This process is identical to the process of S150 in FIG. 3.

In S560, the CPU 132 cancels the setting in the circuit-controlling unit 174 for the transmission path linking the modem 154 and the telephone network 400, and ends the fax reception process.

However, if the CPU 132 determines that the available capacity in the shared area is insufficient for storing the image data (S540: NO), then in S570 the CPU 132 initializes a variable N. In this process, the CPU 132 sets the variable N to 1 (N←1). In the following description, “n” indicates the value to which the variable N is currently set.

In S580 the CPU 132 divides the image data into data segments having a prescribed size (256 kbytes in the preferred embodiment). In this process, image data for an image represented by a plurality of pages worth of image signals is treated as a single data file and is divided into a plurality of data segments having the prescribed data size to form 1^{st} through i^{th} data segments.

In S590 the CPU 132 stores the n^{th} data segment formed in S580 in the shared area of the RAM 140. The data segment is stored under a filename created by concatenating a series of numbers formed from the date and time at which the process in S590 was performed to the value of the variable N (a number from 1 to i). For example, if the communication was performed on the date “Mar. 20, 2003” and at the time “9:45,” and if the value of the variable N is “1,” then the filename is set to “rx200303200945t001.” After this data segment has been stored in the shared area, the data segment is read and deleted from the PC 200 end (S320 and S330 in FIG. 5).

In S600 the CPU 132 determines whether an (n+1)^{th} data segment exists. Here, the CPU 132 determines that an (n+1)^{th} data segment exists when the value of (n+1) is less than or equal to the value of i (i≧(n+1))”], where i indicates the last number of the data segments.

If the CPU 132 determines that a (n+1)^{th} data segment exists (S600: YES), then in S610 the CPU 132 waits until the n^{th} data segment has been deleted from the shared area of the RAM 140 (S610: NO). When the n^{th} data segment has been deleted from the shared area (S610: YES), then in S620 the CPU 132 increments the variable N by one (N←n+1) and returns to S590.

When the (n+1)^{th} data segment no longer exists in S600 after repeatedly performing the processes from S590 to S620 (S600: NO), then in S630 the CPU 132 generates specification data indicating that the plurality of data segments repeatedly stored in the shared area in S590 was produced by dividing image data received through a single facsimile communication and stores the specification data in the shared area of the RAM 140. The specification data generated and stored in the shared area in this process is text data that specifies the filename for each data segment stored in S590, the procedure for combining these data segments, and a filename for the image data produced by combining the data segments (hereinafter referred to as the combined filename). After the specification data are stored in the shared area, the specification data is read and deleted from the PC 200 end. The combined filename is produced by deleting the page number from the filename having the largest page number. The procedure for combining the data segments indicates how to combine data segments to restore the original image data file (for example, a dividing/joining algorithm well known in the art).

After completing the process in S630, the CPU 132 cancels the transmission path set in S560 and ends the fax reception process. As in the first embodiment, processes related to normal facsimile communications are performed during the processes of S520 and S530 described above. However, a description of these processes has been omitted since such a description is not important in understanding the present invention.

Data acquisition process executed by the CPU 212 of the PC 200 according to the fourth embodiment is the same as that of the first embodiment with reference to FIG. 5. That is, when the CPU 212 determines in S310 of FIG. 5 that a data segment has been stored in the shared area of the RAM 140 (stored in S590 at FIG. 10), then in S320 the CPU 212 reads this data segment and stores the data on the HD 220. In S330 the CPU 212 deletes the original data segment from the shared area.

With the communication system having this construction image data received on the multifunction device 100 end can be divided into a plurality of data segments and stored in the shared area of the RAM 140 (S580 in FIG. 10).

Further, by storing specification data in association with the data segments in the shared area through operations on the multifunction device 100 end (S630 in FIG. 10), the original image data can be restored by combining the data segments into a single data file based on the specification data through operations on the PC 200 end (S370 in FIG. 5). Since the specification data can specify procedure for combining the data segments to restore the original image data, the PC 200 can recreate the original image data from the data segments without the need for establishing rules for dividing image data in advance.

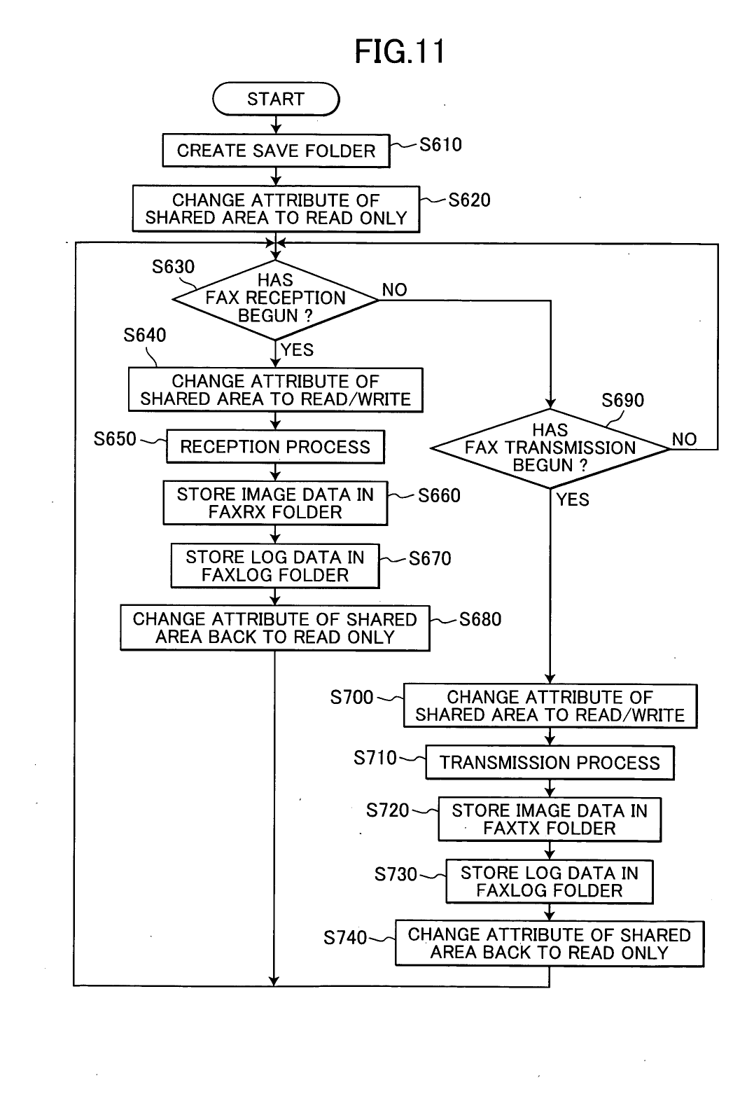

Next, a communication process according to a fifth embodiment of the present invention will be described with reference to FIGS. 11 through 13. A communication system identical to that shown in FIG. 1 is employed in the fifth embodiment.

In addition to various application programs, the HD 220 stores a history accumulation program for performing a history accumulation process described later.

Next, a facsimile communication process executed by the CPU 132 of the multifunction device 100 will be described with reference to FIG. 11. This process is repeatedly executed while ON state of the multifunction device 100 is maintained.

In S610, the CPU 132 generates a save folder in the shared area of the RAM 140 for saving facsimile communication history. In this process, a FAXHISTORY folder is created under the root directory of the shared area as shown in FIG. 12(a). In addition, FAXTX, FAXRX, and FAXLOG folders are created within the FAXHISTORY folder. The PC 200 can recognize these folders as a directory structure of an external storage device (removable disc (F:)), as shown in FIG. 12(b).

In S620 the CPU 132 changes the initialized attribute of the shared area from read/write to read only. The read/write attribute indicates that the data can be overwritten (stored and deleted) based on commands received from an external source, while the read only attribute indicates that data may not be overwritten by commands received from an external source. Both attributes allow data to be read from the shared area.

In S630 the CPU 132 determines whether a fax reception process has begun. The CPU 132 determines that a fax reception process has begun when image signals are initially inputted from the telephone network 400 via the circuit-controlling unit 174.

If a fax reception process has begun (S630: YES), then in S640 the CPU 132 changes the attribute of the shared area from read only to read/write. Then, in S650 the CPU 132 performs a reception process through facsimile communications. In this process, the CPU 132 sets a signal transmission path in the circuit-controlling unit 174 to a path connecting the modem 154 and the telephone network 400, enabling image signals to be transmitted along this path. Next, the modem 154 generates image data by demodulating and decoding image signals sequentially inputted from the telephone network 400 via the circuit-controlling unit 174. Subsequently, the CPU 132 controls the printing unit 156 to print an image represented by this image data. Accordingly, an image represented by image signals inputted from the telephone network 400 is printed on paper. At this time, the CPU 132 cancels the setting in the circuit-controlling unit 174 for the transmission path connecting the modem 154 and the telephone network 400, thereby preventing image signals from being transferred along this path.

In S660 the CPU 132 stores the image data generated by the modem 154 in S650 in the FAXRX folder of the RAM 140. In this process, the image data is stored under a filename that includes a series of numbers formed from the date and time at which the facsimile communication in S650 was performed. For example, if the communication was performed on the date “Mar. 17, 2003” and at the time “16:55,” then the filename is set to “RX200303171655.”

In S670 the CPU 132 stores log data indicating details of the facsimile communication performed in S650 in the FAXLOG folder of the RAM 140. This log data includes data specifying the date, time, communication type indicating a transmission or a reception, identification number for the other party, duration of the communication, size of the transferred data (number of pages in the preferred embodiment), communication result indicating whether the transfer was successful or a failure, and the filename of the image data stored in S660. In the process of S670, the log data is stored under a filename including a sequence of numbers formed from the date and time of the facsimile communication (RX200303171655LOG), as in the process of S660.

In S680 the CPU 132 returns the attribute of the shared area in RAM 140 from read/write to read only, and returns to S630.

On the other hand, if a facsimile reception has not begun in S630 (S630: NO), then in S690 the CPU 132 determines whether a facsimile transmission process has begun.

In this process, the CPU 132 determines that a fax transmission process has begun when the user performs the fax transmission operation as described above.

If a fax transmission process has not begun (S690: NO), then the CPU 132 returns to S630. However, if the CPU 132 determines that a fax transmission process has begun (S690: YES), then in S700 the CPU 132 changes the attribute of the shared area in the RAM 140 from read only to read/write.

In S710 the CPU 132 performs a transmission process according to facsimile communications. In this process, as in the process of S650, the CPU 132 sets the signal transmission path in the circuit-controlling unit 174 to a path connecting the modem 154 and the telephone network 400. Next, the CPU 132 controls the scanning unit 152 to read an original image and generate image data from that original image. The modem 154 is then controlled to encode and modulate this image data to generate image signals capable of being transferred on the telephone network 400. The modem 154 outputs these image signals to the circuit-controlling unit 174, enabling the image signals to be outputted to the telephone network 400 end (transmission destination). As in the process of S650, the CPU 132 then cancels the transmission path setting in the circuit-controlling unit 174 connecting the modem 154 and the telephone network 400.

In S720 the CPU 132 stores the image data generated by the scanning unit 152 in S710 in the FAXTX folder of the RAM 140. In this process, the image data is stored under a filename including a sequence of numbers formed from the date and time at which the facsimile communication in S710 was performed. For example, if the communication was performed on the date “Mar. 17, 2003” and at the time “16:55,” then the filename is set to “TX200303171655.”

In S730 the CPU 132 stores log data indicating details of the facsimile communication performed in S710 in the FAXLOG folder of the RAM 140. As in the process of S670, the log data recorded in this process includes data specifying the date, time, communication type, identification number, duration of the communication, data size, communication result, and filename of the image data stored in S720. As in the process of S720, log data stored in S730 is recorded under a filename including a sequence of numbers formed from the date and time at which the facsimile communication was performed (TX200303171655LOG). In S740 the CPU 132 returns the attribute of the shared area from the read/write attribute to read only.

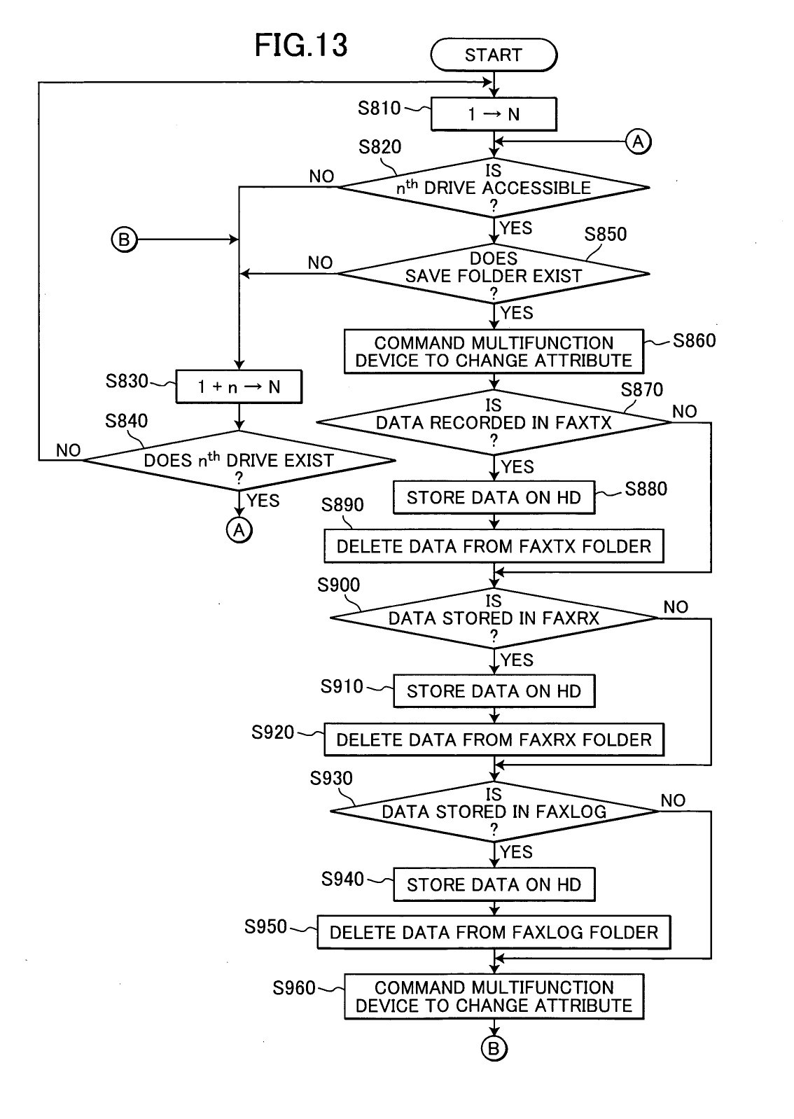

Next, history accumulation process executed by the CPU 212 of the PC 200 according to the fifth embodiment will be described with reference to FIG. 13. This process is repeatedly executed while the history accumulation program is running.

First, the CPU 212 initializes a variable N in S810. In this process, the CPU 212 sets the variable N to 1 (N←1). In the description below, “n” indicates the current value of the variable N.

In S820 the CPU 212 determines whether the n^{th} drive can be accessed. In this process, the CPU 212 determines whether it is possible to access the n^{th} drive from among all drives (storage devices) that can be recognized by the CPU 212 (drives A-F in FIG. 12(b)) beginning from drive A. By attempting to access these drives, the CPU 212 can determine whether a storage medium such as a floppy disk, CD-ROM, or the memory card 500 is mounted in the mountable drives.

If the n^{th} drive cannot be accessed (S820: NO), then in S830 the CPU 212 increments the variable N by 1 (N←n+1). In S840 the CPU 212 determines whether the n^{th} drive exists. Here, the CPU 212 determines whether another drive exists that can be recognized by the CPU 212 based on the order shown in FIG. 12(b) beginning from drive A.

If the n^{th} drive does not exist (S840: NO), then the CPU 212 returns to S810. However, if the n^{th} drive exists (S840: YES), then the CPU 212 returns to S820.

When the n^{th} drive can be accessed in the process of S820 described above (S820: YES), then in S850 the CPU 212 determines whether a save folder exists on the n^{th} drive. The CPU 212 determines that a save folder exists in this process when the FAXHISTORY folder exists in the root directory of the n^{th} drive and the FAXTX, FAXRX, and FAXLOG folders exist in the FAXHISTORY folder as shown in FIG. 12(b).

If the CPU 212 determines that the save folder does not exist (S850: NO), then the CPU 212 advances to S830. However, if the CPU 212 determines that a save folder exists (S850: YES), then in S860 the CPU 212 issues a command to the multifunction device 100 to change the attribute of the shared area in the RAM 140 to read/write. In this process, the CPU 212 transmits a command signal to the multifunction device 100 for modifying the attribute of the shared area. Upon receiving this command signal, the multifunction device 100 changes the attribute of the shared area to read/write.

In S870 the CPU 212 determines if data has been stored in the FAXTX folder within the FAXHISTORY folder in the shared area. Image data is stored in the FAXTX folder in the process of S720 in FIG. 11.

If data has been stored in the FAXTX folder (S870: YES), then in S880 the CPU 212 stores this data on the HD 220. In this process, the CPU 212 records image data stored in the FAXTX folder in a predetermined storage area on the HD 220 that has been provided for storing such image data.

In S890 the CPU 212 deletes the image data from the FAXTX folder in the shared area. After completing the process of S890, or when no data has been stored in the FAXTX folder (S870: NO), then in S900 the CPU 212 determines whether data has been stored in the FAXRX folder within the FAXHISTORY folder in the shared area. Image data may be stored in the FAXRX folder during the process of S660 in FIG. 11.

If data has been stored in the FAXRX folder (S900: YES), then in S910 the CPU 212 stores this data on the HD 220. In this process, data stored in the FAXRX folder is recorded in a predetermined storage area on the HD 220 that has been provided for storing such data.

In S920 the CPU 212 deletes this image data from the FAXRX folder. After completing the process in S920, or when data has not been stored in the FAXRX folder (S900: NO), then in S930 the CPU 212 determines whether data has been stored in the FAXLOG folder within the FAXHISTORY folder in the shared area. Image data may be stored in the FAXLOG folder during the process of S670 or S730 in FIG. 11.

If data has been stored in the FAXLOG folder (S930: YES), then in S940 the CPU 212 records this data on the HD 220. In this process, log data stored in the FAXLOG folder is recorded in a predetermined storage area on the HD 220 that has been provided for storing such data.

In S950 the CPU 212 deletes this log data from the FAXLOG folder in the shared area. After completing the process of S950, or when no data has been stored in the FAXLOG folder (S930: NO), in S960 the CPU 212 issues a command to the multifunction device 100 to change the attribute of the shared area in the RAM 140 to the read only attribute, and subsequently advances to S830.

With the communication system having this construction, image data or log data stored in the shared area of the RAM 140 on the multifunction device 100 end (S660, S670, S720, and S730 in FIG. 11) can automatically be recorded in the HD 220 on the PC 200 end (S880, S910, and S940 in FIG. 13).

Accordingly, when the multifunction device 100 performs facsimile communications and log data showing the details of the facsimile communication is recorded on the multifunction device 100 end, the user need not perform a deliberate operation on the PC 200 to transfer this log data to the PC 200 end. Thus, the communication system according to the fifth embodiment provides a more user-friendly method of saving and managing log data on the PC 200 end than a method requiring the user to perform a deliberate operation.

This process is particularly advantageous in preventing data unrelated to communication details from being mistakenly read by the user and stored on the PC 200 end, since any data stored in the FAXLOG folder of the shared area is read as log data. This process can also prevent data unrelated to image data obtained through facsimile communications from being mistakenly read and stored on the PC 200 end, since any data stored in the FAXTX and FAXRX folders in the shared area is read as image data.

Further, when data is stored in the shared area of the RAM 140, the PC 200 records this data on the HD 220 (S880, S910, and S940 in FIG. 13). However, by allowing this log data to remain on the multifunction device 100 end after copying the data on the PC 200 end, there is a risk that the same log data may be stored repeatedly on the PC 200 end. Therefore, in the present embodiment, the log data is deleted from the shared area on the multifunction device 100 end after being stored on the HD 220 (S890, S920, and S950 in FIG. 13), preventing the same log data from being copied more than once.

Further, since the data itself is deleted from the RAM 140 in the multifunction device 100, there is no risk of unnecessary data occupying the RAM 140, thereby making effective use of the storage area in the RAM 140.

Further, the image data and log data can be stored in separate folders on the multifunction device 100 end. Hence, it is possible to distinguish between image data and log data based on the folder name in the shared area when copying the data onto the HD 220. In this way, both the log data and the image data itself may be saved on the PC 200 end.

Further, the PC 200 performs a process to store data from a drive onto the HD 220 only when a save folder exists on the n^{th} drive in S850 of FIG. 13. Therefore, when the PC 200 is connected to devices other than the multifunction device 100 that can be recognized as storage devices, the process of the present embodiment can prevent data other than image data and log data on the other storage devices from being mistakenly stored on the PC 200 end when such data exists on these storage devices.

Further, the multifunction device 100 sets the attribute of the shared area in the RAM 140 to read/write only while a fax is being received and until the received data is stored in the RAM 140, when a fax is being transmitted and until the data is stored in the RAM 140, and while commands are being received from the PC 200 and until the data is read and deleted from the RAM 140, enabling data to be stored and deleted during these period. Therefore, data cannot be stored in nor deleted from the shared area of the RAM 140 even if the user operating the multifunction device 100 or the PC 200 mistakenly attempts to store data in the shared area or attempts to delete data therefrom, thereby preventing the storage of unnecessary data and the deletion of necessary data.

A communication system according to a sixth embodiment has a construction identical to the communication system of the fifth embodiment. The sixth embodiment only differs from the fifth embodiment in part of the process that is performed. Only these differences will be described below.

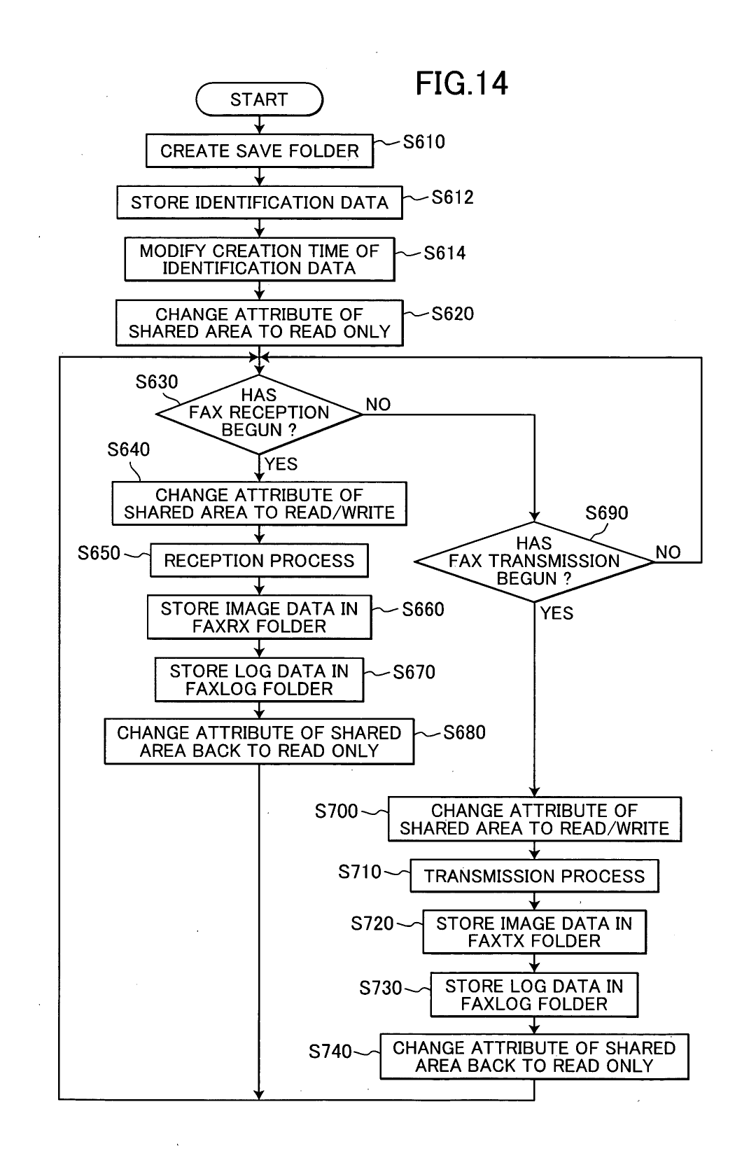

A facsimile communication process executed by the CPU 132 of the multifunction device 100 according the sixth embodiment will be described next with reference to FIG. 14. This process differs from the process according to the fifth embodiment shown in FIG. 11 by the steps added between S610 and S620.

After creating a save folder in S610, in S612 the CPU 132 stores identification data in the root directory of the shared area in the RAM 140. The “identification data” serves to identify the multifunction device 100 as a device that stores image data and log data in the RAM 140.

In S614 the CPU 132 modifies the creation time for the identification data stored in S612 to the sum of the creation times for each folder created in S610. In this process, the CPU 132 first adds the creation hour for each of the FAXTX, FAXRX, and FAXLOG folders and modifies the creation hour of the identification data to this sum. More specifically, if each of these folders was created in the twenty-first hour, then the creation hour for the identification data is calculated as (21+21+21)mod24=15. Next, the creation minute for each of the FAXTX, FAXRX, and FAXLOG folders is added, and the creation minute of the identification data is modified to this sum. More specifically, if the FAXTX and FAXRX folders were created in the fifty-second minute while a FAXLOG folder was created in the fifty-third minute, then the creation minute for the identification data is calculated as (52+52+53)mod60=37. After completing the process in S614, the CPU 132 advances to S620.

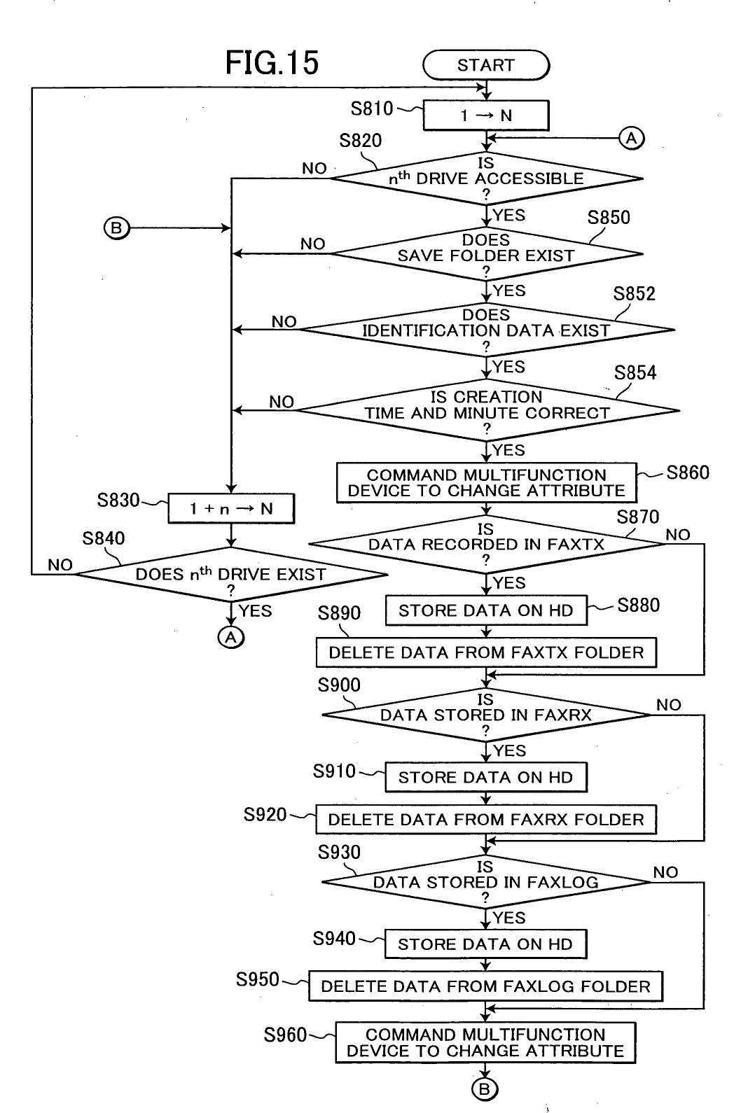

History accumulation process executed by the CPU 212 of the PC 200 according to the sixth embodiment will be described next with reference to FIG. 15. This process differs from the process according to the fifth embodiment shown in FIG. 13 in that the steps S852 and S854 are inserted between S850 and S860.

If the CPU 212 is able to access the n^{th} drive in S820, then in S852 the CPU 212 determines whether identification data has been stored in the root directory of the drive.

If identification data has not been stored in the root directory (S852: NO), then the CPU 212 advances to S830. However, if identification data is stored in the root directory (S852: YES), then in S854 the CPU 212 determines whether the creation time for the identification data is correct. In this process, the CPU 212 performs the same calculations performed in S614 of FIG. 14 for adding the hour and minute of creation for each of the FAXTX, FAXRX, and FAXLOG folders located in the FAXHISTORY folder of the n^{th} drive. The CPU 212 determines that the creation time for the identification data is correct when this creation time matches the calculated values.

If the creation time for the identification data is not correct (S854: NO), then the CPU 212 advances to S830. However, if the creation time is correct (S854: YES), then the CPU 212 advances to S860.

The communication system in the sixth embodiment can achieve the following effects owing to the differences in operations from those performed in the fifth embodiment.

With the communication system having the construction described above, the PC 200 performs a process to store data recorded on a drive onto the HD 220 (S860 and subsequent processes in FIG. 15) only when the CPU 212 determines that proper identification data has been stored on the drive (S852). Accordingly, if the PC 200 is connected to a storage device other than the multifunction device 100 that can be recognized as a storage device and a save folder has been stored on the other storage device, there is little possibility that data similar to identification data has been stored on the storage device. Hence the communication system can prevent data other than image data and log data from being mistakenly stored on the PC 200 end.

Further, the PC 200 performs a process to store image data and log data recorded on a drive onto the HD 220 only when identification data has been stored on the drive and when the hour and minute that the identification data was created matches the hour and minute calculated for each folder (S854 in FIG. 15). Accordingly, if the PC 200 is connected to a device other than the multifunction device 100 that can be recognized as a storage device, and if a save folder has been stored on the storage device, and even if data similar to identification data has been stored on the storage device, there is very little possibility that the hour and minute at which the identification data was created will match the hour and minute calculated from the save folder stored on the storage device. Therefore, the communication system further reduces the chance that data other than image data and log data will be mistakenly stored on the PC 200 end.

While the invention has been described in detail with reference to specific embodiments thereof, it would be apparent to those skilled in the art that various changes and modifications may be made therein without departing from the spirit of the invention, the scope of which is defined by the attached claims.

For example, in the embodiments described above, the communication system of the present invention is applied to a computer system including the multifunction device 100 and the PC 200. However, this computer system may be configured of devices other than the multifunction device 100 and PC 200 and may be configured of one, or three or more devices.

Further, in the embodiments described above, processes shown in the flowcharts are executed by a computer system including the CPU 132 in the multifunction device 100 and the CPU 212 in the PC 200. However, part or all of these processes may be executed by a separate computer system connected to the multifunction device 100 and the PC 200 via wired or wireless signal transmission paths.

Further, in the multifunction device 100 of the embodiments described above, processes shown in the flowcharts are executed according to a computer program stored in the ROM 134. However, this computer program may instead be stored on the memory card 500. In this case, the processes shown in the flowcharts may be executed according to the computer program stored on the memory card 500 when the memory card 500 is mounted in the media drive 180.

Further, in the PC 200 of the embodiments described above, the processes shown in the flowcharts are executed according to a computer program stored on the HD 220. However, if the PC 200 is configured to perform data input and output with a storage medium, such as a floppy disk, CD-ROM, and a memory card, the PC 200 may execute the processes shown in the flowcharts based on the computer program stored on the storage medium.

Further, the telephone network 400 in the embodiments described above may be a public switched telephone network (PSTN) or an IP telephone network.

Further, in the embodiments described above, the multifunction device 100 is configured to transmit and receive image signals (facsimile communications) via the telephone network 400. However, the multifunction device 100 may be configured to perform facsimile communications via the Internet when capable of performing data communications via the Internet.

Further, in the embodiments described above, various data is exchanged between the multifunction device 100 and the PC 200 using the shared area in the RAM 140 of the multifunction device 100. However, this exchange of data may also be performed in the memory card 500 mounted in the media drive 180. In the latter case, the “shared area of the RAM 140” described in the preferred embodiments should be replaced by the “memory card 500 mounted in the media drive 180.”

Further, in the embodiments described above, the multifunction device 100 is configured to store image data (log data) and specification data (transmission/reception data) for facsimile communications in the shared area of the RAM 140. However, the multifunction device 100 may be configured to store communication data (log data) and specification data (transmission/reception data) for data communications performed via the Internet in the shared area when capable of performing data communications via the Internet. In this case, the history of the data communications performed via the Internet can be saved and managed on the PC 200 end.

Further, in the embodiments described above, the processes in FIGS. 3, 7, 9, and 10 illustrate a process for receiving image data through facsimile communications. However, these processes can also be applied to a process for transmitting image data through facsimile communications. In this case, “reception” in the embodiments described above should be replaced with “transmission” and the processes in FIGS. 3, 7, 9, and 10 should be replaced with a description for transmitting image data through facsimile communications. For example, the condition for starting each process should be the user performing a fax transmission operation. Further, the filename for data stored in the shared area should be formed of a name that can be differentiated from a filename for received data (for example, “rx20 . . . ” for received data and “tx . . . ” for transmitted data).

Further, in the embodiments described above, the communication system is configured to generate image data from the single pages of image data or the divided data stored on the PC 200 end based on specification data stored together with this data on the multifunction device 100 end. with this data on the multifunction device 100 end. However, it is also possible to predetermine the rules of division and restoration, including methods of setting filenames for each of the image data and dividing procedure, when image data is saved in units of single pages or is divided into a plurality of data segments. In this case, the PC 200 can generate the image data based on these predetermined division rules after single pages worth of image data or data segments are stored on the HD 220. With this construction, the PC 200 can restore communication data from a plurality of data segments simply by determining the division rules in advance.

Further, in the fifth and sixth embodiments described above, data other than image data and log data is prevented from being stored mistakenly on the PC 200 end using hours and minutes calculated based on the hour and minute that each save folder was created (S614 in FIG. 14 and S854 in FIG. 15). However, the configuration for preventing data other than image data and log data from being mistakenly stored on the PC 200 end is not limited to this configuration.

Further, in the fifth and sixth embodiments described above, image data and log data stored on the PC 200 end is deleted from the multifunction device 100 end (S890, S920, and S950 in FIG. 13) in order to prevent the same image data and log data from being stored on the PC 200 end repeatedly. However, the image data and log data stored on the PC 200 end may be moved to a separate folder (such as the root directory) from the folder in which this data was originally stored, as an alternative method to prevent the same image data and log data from being stored repeatedly on the PC 200 end.

Further, in the fifth and sixth embodiments, the multifunction device 100 stores data in a folder determined by the type of data and whether the data was transmitted or received (S660, S670, S720, and S730 in FIG. 11). However, image data and log data may be stored under any conditions, provided that the type of data can be identified on the PC 200 end. For example, on the multifunction device 100 end, the filename used when storing image data and log data in the shared area of the RAM 140 can be set to a specific filename. In this case, the PC 200 can identify whether the data is image data (transmitted or received) or log data based on the filename when storing this data on the HD 220. More specifically, in S660, S670, S720, and S730 in the facsimile communication process in FIG. 14, the multifunction device 100 stores each type of data in the shared area of the RAM 140 under the appropriate received image filename, log data filename, transmitted image filename, or log file filename. Subsequently, in S870, S900, and S930 in the history accumulation process in FIG. 15, the PC 200 can determine whether transmitted image data exists, whether received image data exists, and whether log data exists based on the filenames for files stored in the shared area, and in S880, S910, and S940 the PC 200 can store the relevant data on the HD 220 when such data exists.

Each operation program is provided by a storage medium such as FD, CD-ROM and a memory card those being installable into a computer system. Alternatively, each operation program is also provided by way of communication network such as Internet, so that the operation program can be installed onto a computer system of the multifunction device 100, a computer system of the terminal PC 200, and another computer system connected to one of the computer systems of the multifunction device 100 and the terminal PC 200 with wiring or non wiring system.

1. A communication system comprising a communication device and a terminal device that are connected to and capable of performing data communications with each other,
the communication device comprising:
a communicating unit that performs data communications via a network;
a communication-end storing unit capable of storing various data and capable of being recognized by the terminal device as an external storage device connected to the terminal device; and
a communication-storage commanding unit comprising a judging portion that judges whether or not a communication data transmitted through or received by the communicating unit is satisfied with a prescribed storage condition;
a storing portion that stores a communication data in the communication end storing unit if the communication data is satisfied with the prescribed condition as a result of judgment by the judging unit;
a handling portion that handles a communication data as a plurality of data segments each having a prescribed data size if the communication data is not satisfied with the prescribed condition as a result of judgment by the judging portion; and
a sequentially storing portion that sequentially stores the data segments in the communication-end storing unit; and
the terminal device comprising:
a terminal-end storing unit that stores various data; and
a terminal-end storage commanding unit that stores the communication data or the data segments in the terminal-end storing unit when the communication data or data segments are stored in the communication-end storing unit.

2. The communication system as claimed in claim 1, wherein the terminal device further comprises terminal-end deletion commanding unit that deletes the communication data or the data segments from the communication-end storing unit after the communication data or data segments have been stored in the terminal-end storing unit by the terminal-end storage commanding unit.

3. The communication system as claimed in claim 2, wherein the communication-end storage commanding unit further comprises a generating portion that generates and stores specification data in the communication-end storing unit, the specification data identifying the plurality of data segments as segments of data divided from the communication data; and
wherein the terminal device further comprises data combining unit that creates communication data by combining the data segments stored in the terminal-end storing unit based on the specification data stored in the communication-end storing unit.

4. The communication system as claimed in claim 3, wherein the terminal-end storage commanding unit comprises:
a judging portion that judges storage of the specification data in the communication-end storing unit; and
a storing unit that stores the specification data in the terminal-end storing unit when the specification data is stored in the communication-end storing unit as a result of judgment made by the judging portion that judges storage of the specification data; and
wherein the terminal-end deletion commanding unit deletes the specification data from the communication-end storing unit provided in the communication device after the specification data has been stored in the terminal-end storing unit; and
wherein the data combining unit combines the data segments based on the specification data stored in the terminal-end storing unit.

5. The communication system as claimed in claim 1, wherein the communicating unit is configured to transmit or receive communication data in the data segment basis; and
wherein the storing portion that stores a communication data stores a communication data formed from the data segments transmitted or received by the communicating unit in the communication-end storing unit if the communication data is satisfied with the prescribed condition; and
wherein the sequentially storing portion stores the data segments in the communication-end storing unit each time a data segment is transmitted or received by the communicating unit if the communication data is not satisfied with the prescribed condition.

6. The communication system as claimed in claim 1, wherein the handling portion that handles a communication data comprises a data dividing section that divides communication data transmitted or received by the communicating unit into the data segments if the communication data is not satisfied with the prescribed condition as a result of judgment by the judging portion, the sequentially storing portion storing in the communication-end storing unit the divided data segments when the communication data has been divided into the data segments by the data dividing section.

7. The communication system as claimed in claim 1, wherein the prescribed storage condition comprises a storage capacity of a remaining area in the communication-end storage unit indicating an available storage area for storing communication data, the storage condition being satisfied if the storage capacity is greater than or equal to a pre-scribed threshold value.

8. The communication system as claimed in claim 1, wherein the storage condition comprises a specific parameter associated with the communication data transmitted or received by the communicating unit, the storage condition being satisfied if the communication data is associated with the specific parameter.

9. The communication system as claimed in claim 8, wherein the communication data comprises image data; and
wherein the specific parameter comprises the number of colors in an image represented by the image data, the storage condition being satisfied if the number of colors in the image is greater than or equal to a prescribed number.

10. The communication system as claimed in claim 8, wherein the communication data comprises image data; and
wherein the specific parameter comprises a resolution of an image, the storage condition being satisfied if a resolution of an image is greater than or equal to a pre-scribed threshold value.

11. The communication system as claimed in claim 1, wherein the communication device further comprises mode switching unit that switches, by a user's operation, an operating mode of the communication device between a normal mode for storing communication data transmitted or received by the communicating unit in the communication-end storing unit unchanged by the storing portion that stores a communication data, and a divided mode for storing the data segments in the communication-end storing unit by the sequentially storing portion when communication data is transmitted or received by the communicating unit, the prescribed storage condition being satisfied if the operation mode is switched to the normal mode by the switching unit.

12. A communication system comprising a communication device and a terminal device that are connected to and capable of performing data communications with each other,
the communication device comprising:
a communicating unit that performs data communications via a network;
a communication-end storing unit capable of storing various types of data and capable of being recognized by the terminal device as an external storage device connected to the terminal device; and
a communication-end storage commanding unit that stores description data indicating details of communications performed by the communicating unit in the communication-end storing unit in a state that satisfies a prescribed storage condition; and
the terminal device comprising:
a terminal-end storing unit that stores various types of data; and
a terminal-end storage commanding unit that treats the description data as the data for satisfying the storage condition and stores in the terminal-end storing unit the description data from among all data stored in the communication-end storing unit.

13. The communication system as claimed in claim 12, wherein the terminal device further comprises terminal-end deletion commanding unit that deletes data from the communication-end storing unit that is identical to data stored in the terminal-end storing unit by a command from the terminal-end storage commanding unit.

14. The communication system as claimed in claim 12, wherein the communication-end storage commanding unit stores communication data transmitted or received by the communication unit in the communication-end storing unit in a state that satisfies a prescribed first storage condition, and stores description data indicating communication details of the communication data in the communication-end storing unit in a state that satisfies a prescribed second storage condition; and
wherein the terminal-end storage commanding unit treats the communication data as data that satisfies the first storage condition and treats the description data as data that satisfies the second storage condition from among data stored in the communication-end storing unit and, stores the communication data and the description data in the terminal-end storing unit.

15. The communication system as claimed in claim 12, wherein the communication-end storage commanding unit stores data in a specific storage area of the communication-end storing unit in order to satisfy the storage condition; and
wherein the terminal-end storage commanding unit stores data located in the specific storage area of the communication-end storing unit in the terminal-end storing unit.

16. The communication system as claimed in claim 12, wherein the communication device further comprises a storing unit that stores identification data in the communication-end storing unit, the identification data identifying the communication device as a device configured to store description data; and
wherein the terminal-end storage commanding unit commands storage of data into the terminal-end storing unit when the identification data has been stored in the communication-end storing unit.

17. The communication system as claimed in claim 16, wherein the identification data stored in the communication-end storing unit comprises computation data calculated from prescribed target data stored in the communication-end storing unit according to a specific procedure; and
wherein the terminal-end storage commanding unit commands storage of data into the terminal-end storing unit only when the identification data is stored in the communication-end storing unit provided in the communication device and when the computation data indicated by the identification data is in conformance with data calculated from the target data stored in the communication-end storing unit according to the specific procedure.

18. The communication system as claimed in claim 13, wherein the communication device further comprises a status switching unit that switches the operating status of the communication-end storing unit between a modifiable state in which data can be stored to or deleted from the communication-end storing unit and a non-modifiable state in which data cannot be stored or deleted; and
the status switching unit switches the operating status of the communication-end storing unit to the modifiable state when the communication-end storage commanding unit commands the communication-end storing unit to store data and until the data is stored in the communication-end storing unit, and when the communication-end deletion commanding unit commands the communication-end storing unit to delete data and until the data has been deleted from the communication-end storing unit.

19. A first storage medium containing a program for performing data communication between a communication device and a terminal device, the communication device including communication-end storing unit capable of storing various data and capable of being recognized by the terminal device as an external storage device connected to the terminal de-vice, the first program comprising:
a program of performing data communication via a net-work; and
a program of commanding storage in the communication-end storing unit, comprising
a program of judging whether or not a communication data transmitted through or received by the communicating unit is satisfied with a prescribed storage condition;
a program of storing a communication data in the communication end storing unit if the communication data is satisfied with the prescribed condition as a result of the judgment;
a program of handling a communication data as a plurality of data segments each having a prescribed data size if the communication data is not satisfied with the prescribed condition as a result of the judgment; and
a program of sequentially storing the data segments in the communication-end storing unit.

20. A second storage medium containing a program for performing data communication between a communication device and a terminal device for use in combination with the first storage medium as claimed in claim 19, the terminal device including terminal-end storing unit that stores various data, the program comprising:
a program of commanding storage of the communication data or the data segments in the terminal-end storing unit when the communication data or data segments are stored in the communication-end storing unit.

21. The second storage medium as claimed in claim 20, wherein the program further comprises a program of commanding deletion of the communication data or the data segments from the communication-end storing unit after the communication data or data segments have been stored in the terminal-end storing unit.

22. A third storage medium containing a program for performing data communication between a communication device and a terminal device, the communication device including communication-end storing unit capable of storing various types of data and capable of being recognized by the terminal device as an external storage device connected to the terminal device, the program comprising:
a program of performing data communications via a net-work;
a program of commanding storage in the communication-end storing unit of description data indicating details of communications performed by the data communication program in the communication-end storing unit in a state that satisfies a prescribed storage condition.

23. A fourth storage medium containing a program for performing data communication between a communication device and a terminal device for use in combination with the third storage medium as claimed in claim 22, the terminal device including terminal-end storing unit that stores various types of data, the program comprising: a program of treating the description data as the data for satisfying the storage condition and commanding storage in the terminal-end storing unit of the description data from among all data stored in the communication-end storing unit.

24. The fourth storage medium as claimed in claim 23 wherein the program further comprises a program of deleting data from the communication-end storing unit that is identical to data stored in the terminal-end storing unit by a command from the commanding program.
